(19) United States
(12) Patent Application Publication
(10) Pub. No.: US 2024/0287336 A1
(43) Pub. Date: Aug. 29, 2024

(54) Ink Jet Ink Composition And Recording Method

(71) Applicant: SEIKO EPSON CORPORATION, Tokyo (JP)

(72) Inventors: Hiromi NOGUCHI, Shiojiri (JP); Hidehiko KOMATSU, Chino (JP); Yasuhiro OKI, Matsumoto (JP); Hisashi OKAMURA, Shiojiri (JP)

(21) Appl. No.: 18/588,116

(22) Filed: Feb. 27, 2024

(30) Foreign Application Priority Data
Feb. 28, 2023 (JP) 2023-029815

(51) Int. Cl. C09D 11/36

(52) U.S. Cl. CPC C09D 11/36

(57) ABSTRACT

An ink jet ink composition contains at least one dye, an organic solvent, and water. The ink jet ink composition contains, as the organic solvent, at least one selected from the group consisting of 1-(2-hydroxyethyl)-2-pyrrolidone and 2-pyrrolidone and the compound represented by formula (1) below.

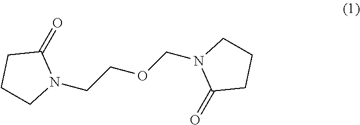 [SMILES: O=C1CCCN1CCOCN1CCCC1=O]

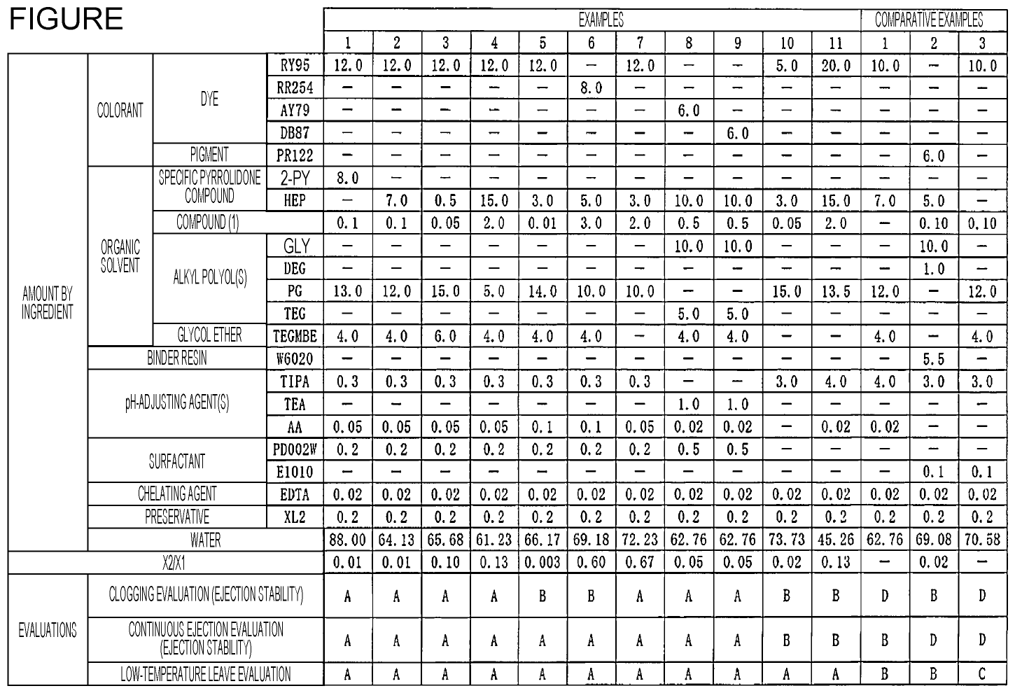

The present application is based on, and claims priority from JP Application Serial Number 2023-029815, filed Feb. 28, 2023, the disclosure of which is hereby incorporated by reference herein in its entirety.

### BACKGROUND

### 1. Technical Field

The present disclosure relates to an ink jet ink composition and a recording method.

### 2. Related Art

Ink jet technology has not only been applied to the recording of images on recording media, but its application to textile printing on fabric has also been attempted. Different types of ink compositions for ink jet textile printing are under ongoing study. Ink jet ink compositions for textile printing contain a colorant so that images in the desired color will be obtained, with the colorant being, for example, a dye. Performance requirements for ink jet ink compositions for textile printing, furthermore, are comparable to or more stringent than those for ordinary ink jet ink compositions.

In the field of ink jet ink compositions, the use of an organic solvent as a solvent or dispersion medium is a common practice. Ink jet ink compositions undergo extensive studies regarding the selection of the organic solvent and its quantity to achieve their desired performance. For example, JP-A-2002-371207 describes the use of 3-quinuclidinol as an organic solvent for dissolving or dispersing the colorant, and the 3-quinuclidinol is used in combination with hydroxyethylpyrrolidone.

For inks made with organic solvents like that disclosed in JP-A-2002-371207, however, there are combinations of organic solvents or formulations that lead to issues such as the separation or solidification of the colorant. Reduced ejection stability and slow recovery from clogging have also occurred in some cases.

### SUMMARY

The present disclosure was made to address this disadvantage and can be realized as the following application examples.

An ink jet ink composition according to an application example of the present disclosure is an ink jet ink composition containing at least one dye, an organic solvent, and water, wherein:
the ink jet ink composition contains, as the organic solvent, at least one selected from the group consisting of 1-(2-hydroxyethyl)-2-pyrrolidone and 2-pyrrolidone and a compound represented by formula (1) below.

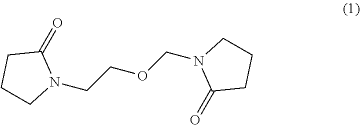 [SMILES: O=C1CCCN1CCOCN1CCCC1=O]

An ink jet ink composition according to another application example of the present disclosure is an ink jet ink composition containing at least one dye, an organic solvent, and water, wherein:
the ink jet ink composition contains, as the organic solvent, at least one selected from the group consisting of 1-(2-hydroxyethyl)-2-pyrrolidone and 2-pyrrolidone, a compound represented by formula (1) below, and at least one selected from the group consisting of alkanediols with three or more and six or fewer carbons and glycol ethers represented by formula (2) below;
a sum of amounts of the 1-(2-hydroxyethyl)-2-pyrrolidone and the 2-pyrrolidone in the ink jet ink composition is 0.5% by mass or more and 15.0% by mass or less;
an amount of the compound represented by formula (1) below in the ink jet ink composition is 0.01% by mass or more and 3.0% by mass or less;
0.001≤X2/X1≤0.80, where X1 is the sum of amounts of the 1-(2-hydroxyethyl)-2-pyrrolidone and the 2-pyrrolidone in the ink jet ink composition in % by mass, and X2 is the amount of the compound represented by formula (1) below in the ink jet ink composition in % by mass;
the dye is at least one water-soluble dye selected from the group consisting of acid dyes, direct dyes, and reactive dyes; and
an amount of the water-soluble dye in the ink jet ink composition is 5.0% by mass or more and 20.0% by mass or less:

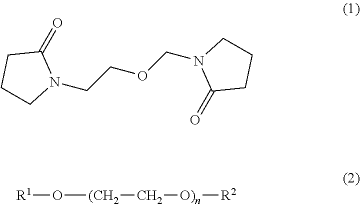

where R¹ is H or an alkyl group with one or more and four or fewer carbons, R² is an alkyl group with one or more and four or fewer carbons, and n is 2 or 3.

A recording method according to an application example of the present disclosure includes attaching an ink jet ink composition according to an application example of the present disclosure to a recording medium by ejecting the ink jet ink composition by ink jet technology.

### BRIEF DESCRIPTION OF THE DRAWING

The FIGURE is a table presenting a summary of the formulation and evaluation results for ink jet ink compositions in examples and comparative examples.

### DESCRIPTION OF EMBODIMENTS

Preferred embodiments of the present disclosure will now be described in detail.

### 1 Ink Jet Ink Composition

First, an ink jet ink composition according to an aspect of the present disclosure will be described.

An ink jet ink composition according to an aspect of the present disclosure contains at least one dye, an organic solvent, and water. The ink jet ink composition contains, as the organic solvent, at least one selected from the group consisting of 1-(2-hydroxyethyl)-2-pyrrolidone and 2-pyrrolidone and the compound represented by formula (1) below.

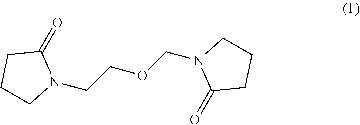 [SMILES: O=C1CCCN1CCOCN1CCCC1=O]

This allows an ink jet ink composition superior in stability in ejection by ink jet technology and also superior in recovery from clogging in an ink jet head to be provided.

### 1-1 Dye

The ink jet ink composition according to this aspect of the present disclosure contains at least one dye.

The dye that the ink jet ink composition according to this aspect of the present disclosure contains is not particularly limited, and examples include water-soluble dyes and disperse dyes. It is, however, preferred that the dye be at least one water-soluble dye.

This helps make the color strength, for example, of the recorded area when the ink jet ink composition according to this aspect of the present disclosure is applied to fabric as a recording medium even better.

As the water-soluble dye, different types of dyes soluble in water can be used. It is, however, preferred that the water-soluble dye be at least one selected from the group consisting of acid dyes, direct dyes, and reactive dyes.

This helps make the color strength, for example, of the recorded area when the ink jet ink composition according to this aspect of the present disclosure is applied to fabric as a recording medium even better.

Examples of acid dyes include dyes such as C.I. Acid Red 1, 6, 8, 9, 13, 14, 18, 19, 24, 26, 27, 28, 32, 35, 37, 42, 51, 52, 57, 62, 75, 77, 80, 82, 83, 85, 87, 88, 89, 92, 94, 95, 97, 106, 111, 114, 115, 117, 118, 119, 127, 128, 129, 130, 131, 133, 134, 138, 143, 145, 149, 151, 154, 155, 158, 168, 180, 183, 184, 186, 194, 198, 199, 209, 211, 215, 216, 217, 219, 249, 252, 254, 256, 257, 260, 261, 262, 263, 265, 266, 274, 276, 282, 283, 289, 299, 301, 303, 305, 315, 318, 320, 321, 322, 336, 337, 361, 396, and 397; C.I. Acid Violet 5, 7, 11, 15, 31, 34, 35, 41, 43, 47, 48, 49, 51, 54, 66, 68, 75, 78, 90, 97, 103, 106, and 126; C.I. Acid Yellow 1, 3, 7, 11, 17, 19, 23, 25, 29, 36, 38, 39, 40, 42, 44, 49, 50, 59, 61, 64, 70, 72, 75, 76, 78, 79, 98, 99, 110, 111, 112, 114, 116, 118, 119, 127, 128, 131, 135, 141, 142, 143, 151, 159, 161, 162, 163, 164, 165, 169, 174, 184, 190, 195, 196, 197, 199, 207, 218, 219, 222, 227, and 246; C.I. Acid Blue 1, 7, 9, 15, 22, 23, 25, 27, 29, 40, 41, 43, 45, 49, 54, 59, 60, 62, 72, 74, 76, 78, 80, 82, 83, 87, 90, 92, 93, 100, 102, 103, 104, 106, 112, 113, 114, 117, 120, 126, 127, 127:1, 128, 129, 130, 131, 133, 138, 140, 142, 143, 151, 154, 156, 158, 161, 166, 167, 168, 170, 171, 175, 181, 182, 183, 184, 185, 187, 192, 193, 201, 203, 204, 205, 207, 209, 220, 221, 224, 225, 229, 230, 232, 239, 247, 249, 258, 260, 264, 271, 277, 277:1, 278, 279, 280, 284, 288, 290, 296, 298, 300, 317, 324, 326, 333, 335, 338, 342, and 350; C.I. Acid Black 1, 2, 7, 24, 26, 29, 31, 44, 48, 50, 51, 52, 52:1, 58, 60, 62, 63, 64, 67, 72, 76, 77, 94, 107, 108, 109, 110, 112, 115, 118, 119, 121, 122, 131, 132, 139, 140, 155, 156, 157, 158, 159, 172, 191, 194, and 234; C.I. Acid Orange 1, 7, 8, 10, 19, 20, 24, 28, 33, 41, 43, 45, 51, 56, 63, 64, 65, 67, 74, 80, 82, 85, 86, 87, 88, 94, 95, 122, 123, and 124; C.I. Acid Green 3, 7, 9, 12, 16, 19, 20, 25, 27, 28, 35, 36, 40, 41, 43, 44, 48, 56, 57, 60, 61, 65, 73, 75, 76, 78, and 79; and C.I. Acid Brown 2, 4, 13, 14, 19, 20, 27, 28, 30, 31, 39, 44, 45, 46, 48, 53, 100, 101, 103, 104, 106, 160, 161, 165, 188, 224, 225, 226, 231, 232, 236, 247, 256, 257, 266, 268, 276, 277, 282, 289, 294, 295, 296, 297, 298, 299, 300, 301, and 302.

Examples of direct dyes include dyes such as C.I. Direct Red 2, 4, 9, 23, 26, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247; C.I. Direct Violet 7, 9, 47, 48, 51, 66, 90, 93, 94, 95, 98, 100, and 101; C.I. Direct Yellow 8, 9, 11, 12, 27, 28, 29, 33, 35, 39, 41, 44, 50, 53, 58, 59, 68, 86, 87, 93, 95, 96, 98, 100, 106, 108, 109, 110, 130, 132, 142, 144, 161, and 163; C.I. Direct Blue 1, 10, 15, 22, 25, 41, 55, 67, 68, 71, 76, 77, 78, 80, 84, 86, 87, 90, 98, 106, 108, 109, 120, 151, 156, 158, 159, 160, 153, 168, 189, 192, 193, 194, 199, 200, 201, 202, 203, 207, 211, 213, 214, 218, 225, 226, 229, 236, 237, 244, 248, 249, 251, 252, 264, 270, 280, 288, 289, and 291; and C.I. Direct Black 9, 17, 19, 22, 32, 51, 56, 62, 69, 77, 80, 91, 94, 97, 108, 112, 113, 114, 117, 118, 121, 122, 125, 132, 146, 154, 166, 168, 173, 195, and 199.

Examples of reactive dyes include dyes such as C.I. Reactive Yellow 1, 2, 3, 5, 11, 13, 14, 15, 17, 18, 20, 21, 22, 23, 24, 25, 26, 27, 29, 35, 37, 40, 41, 42, 47, 51, 55, 65, 67, 81, 95, 116, 142, and 161; C.I. Reactive Red 1, 3, 3:1, 4, 13, 14, 17, 19, 21, 22, 23, 24, 24:1, 25, 26, 29, 31, 32, 35, 37, 40, 41, 43, 44, 45, 46, 49, 55, 60, 66, 74, 79, 96, 97, 108, 141, 180, 218, 226, and 245; C.I. Reactive Violet 1, 3, 4, 5, 6, 7, 8, 9, 16, 17, 22, 23, 24, 26, 27, 33, and 34; C.I. Reactive Blue 1, 2, 3, 5, 7, 8, 10, 13, 14, 15, 17, 18, 19, 21, 23, 25, 26, 27, 28, 29, 32, 35, 38, 41, 49, 63, 72, 75, 80, 95, and 190; C.I. Reactive Orange 1, 2, 4, 5, 7, 12, 13, 14, 16, 20, 29, 33, 35, 38, 64, 67, 71, 72, 72:1, 78, 82, 84, 86, 87, 91, 99, 99:1, 107, 113, 122, 124, and 125; and C.I. Reactive Black 1, 3, 4, 5, 7, 8, 11, 12, 14, 17, 21, 23, 26, 31, 32, 34, and 39.

Examples of disperse dyes include dyes such as C.I. Disperse Red 60, 82, 86, 86:1, 92, 152, 154, 167:1, 191, and 279, C.I. Disperse Yellow 64, 71, 86, 114, 153, 163, 233, and 245, C.I. Disperse Blue 27, 60, 73, 77, 77:1, 87, 165, 165:1, 257, and 367, C.I. Disperse Violet 26, 33, 36, and 57, and C.I. Disperse Orange 30, 41, 61, and 80.

When a disperse dye is used, the surface of the disperse dye may be modified through oxidation or sulfonation, for example with ozone, hypochlorous acid, or fuming sulfuric acid, for the purpose of increasing its dispersion stability in the ink jet ink composition. The dispersibility of the disperse dye, furthermore, may be improved by using a dispersant. Examples of dispersants include (meth)acrylic resins and their salts, such as poly(meth)acrylic acid, (meth)acrylic acid-acrylonitrile copolymers, (meth)acrylic acid-(meth)acrylate copolymers, vinyl acetate-(meth)acrylate copolymers, vinyl acetate-(meth)acrylic acid copolymers, and vinylnaphthalene-(meth)acrylic acid copolymers; styrene resins and their salts, such as styrene-(meth)acrylic acid copolymers, styrene-(meth)acrylic acid-(meth)acrylate copolymers, styrene-α-methylstyrene-(meth)acrylic acid copolymers, styrene-α-methylstyrene-(meth)acrylic acid-(meth)acrylate copolymers, styrene-maleic acid copolymers, and styrene-maleic anhydride copolymers; and polymeric compounds including a urethane linkage, which is formed through the reaction between an isocyanate group and a hydroxyl group. These may be linear-chain or may be branched, and may be with or without a crosslink structure. Other examples include water-soluble resins such as urethane resins and their salts; polyvinyl alcohols; vinylnaphthalene-maleic acid copolymers and their salts; vinyl acetate-maleate copolymers and their salts; and vinyl acetate-crotonic acid copolymers and their salts.

Examples of commercially available styrene-acrylic resin dispersants include X-200, X-1, X-205, X-220, and X-228 (manufactured by Seiko PMC Corporation), SN-DISPERSANT® 6100 and 6110 (manufactured by San Nopco Ltd.), Joncryl 67, 586, 611, 678, 680, 682, and 819 (manufactured by BASF SE), DISPERBYK-190 (manufactured by BYK Japan KK), and N-EA137, N-EA157, N-EA167, N-EA177, N-EA197D, N-EA207D, and E-EN10 (manufactured by DKS Co., Ltd.).

Examples of commercially available acrylic resin dispersants include BYK-187, BYK-190, BYK-191, BYK-194N, and BYK-199 (manufactured by BYK-Chemie GmbH) and Aron A-210, A6114, AS-1100, AS-1800, A-30SL, A-7250, and CL-2 (manufactured by Toagosei Co., Ltd.).

Examples of urethane resin dispersants include BYK-182, BYK-183, BYK-184, and BYK-185 (manufactured by BYK-Chemie GmbH), TEGO Dispers 710 (manufactured by Evonik Tego Chemie GmbH), and Borchi® Gen 1350 (manufactured by OMG Borchers GmbH).

When the ink jet ink composition contains a water-soluble dye as the dye, the percentage of the water-soluble dye in the ink jet ink composition is not particularly limited. It is, however, preferred that the percentage be 5.0% by mass or more and 20.0% by mass or less, more preferably 5.5% by mass or more and 18.0% by mass or less, even more preferably 6.0% by mass or more and 15.0% by mass or less.

This makes it easier to ensure a higher color density in recorded areas formed using the ink jet ink composition. In the related art, furthermore, ensuring the solubility of a water-soluble resin in such an ink jet ink composition in which the percentage of a water-soluble dye is high has been challenging, often leading to inferior stability in ejection by ink jet technology and recovery from clogging. According to this aspect of the present disclosure, however, sufficient solubility of a water-soluble resin can be ensured even in an ink jet ink composition in which the percentage of a water-soluble dye is high as described above; stability in ejection by ink jet technology and recovery from clogging are excellent even with such an ink composition. When the percentage of a water-soluble dye in the ink jet ink composition is a value in the ranges specified above, therefore, the advantages of this aspect of the present disclosure become more significant.

### 1-2 Water

The ink jet ink composition according to this aspect of the present disclosure contains water.

The water is a component that functions as, for example, a solvent, in which the dye and other ingredients in the ink jet ink composition are dissolved, or a dispersant, in which the ingredients are dispersed.

By virtue of the inclusion of water in the ink jet ink composition, furthermore, 1-(2-hydroxyethyl)-2-pyrrolidone, 2-pyrrolidone, and the compound represented by formula (1) above, for example, are contained uniformly in the ink jet ink composition. This allows them to perform their functions more effectively.

The percentage of water in the ink jet ink composition according to this aspect of the present disclosure is preferably 30.0% by mass or more and 90.0% by mass or less, more preferably 40.0% by mass or more and 85.0% by mass or less, even more preferably 45.0% by mass or more and 80.0% by mass or less.

This allows ingredients such as 1-(2-hydroxyethyl)-2-pyrrolidone, 2-pyrrolidone, and the compound represented by formula (1) above to be contained more uniformly in the ink jet ink composition. More reliable adjustment of the viscosity of the ink jet ink composition to a preferred value, furthermore, is enabled, helping further improve stability in ejection by ink jet technology.

### 1-3 Organic Solvent

The ink jet ink composition according to this aspect of the present disclosure contains an organic solvent.

Notably, the organic solvent as a component of the ink jet ink composition according to this aspect of the present disclosure is one that contains, at least, at least one selected from the group consisting of 1-(2-hydroxyethyl)-2-pyrrolidone and 2-pyrrolidone and the compound represented by formula (1) below. In the following description, 1-(2-hydroxyethyl)-2-pyrrolidone and 2-pyrrolidone are also collectively referred to as “the specific pyrrolidone compounds.”

### 1-3-1 Specific Pyrrolidone Compounds

The ink jet ink composition according to this aspect of the present disclosure contains at least one selected from the group consisting of the specific pyrrolidone compounds, i.e., 1-(2-hydroxyethyl)-2-pyrrolidone and 2-pyrrolidone.

The specific pyrrolidone compounds are compounds with high hydrophilicity. By virtue of the inclusion of such a specific pyrrolidone compound, the solubility of the dye, water-soluble dyes in particular, in the ink jet ink composition is high, making it less likely that the separation and solidification of the dye will occur. This helps make the ink jet ink composition superior in ejection stability and recovery from clogging. Such an advantage becomes more significant when the concentration of the dye in the ink jet ink composition is high.

The ink jet ink composition according to this aspect of the present disclosure may contain both of 1-(2-hydroxyethyl)-2-pyrrolidone and 2-pyrrolidone as the specific pyrrolidone compounds, but preferably contains only one of these.

The amount of the specific pyrrolidone compounds, i.e., the sum of the amounts of 1-(2-hydroxyethyl)-2-pyrrolidone and 2-pyrrolidone, in the ink jet ink composition is preferably 0.5% by mass or more and 15.0% by mass or less, more preferably 1.0% by mass or more and 12.0% by mass or less, even more preferably 2.0% by mass or more and 10.0% by mass or less.

This helps make the solubility of the dye in the ink jet ink composition better. It becomes, therefore, more unlikely that the separation and solidification of the dye will occur, helping make the ejection stability and recovery from clogging of the ink jet ink composition better.

### 1-3-2 Compound Represented by Formula (1) Above

The compound represented by formula (1) above is contained in the ink jet ink composition according to this aspect of the present disclosure as a component of the organic solvent.

As stated above, the specific pyrrolidone compounds have excellent functions as solubilizers for dyes. The specific pyrrolidone compounds, however, have a characteristic in which they are likely to increase the viscosity of ink jet ink compositions. An increased viscosity of an ink jet ink composition can result in instable ejection caused by a reduced weight of ink droplets when the ink jet ink composition is ejected from an ink jet head. In this aspect of the present disclosure, it has been noticed that the inclusion of the compound represented by formula (1) above in an ink jet ink composition improves the ejection of the ink jet ink composition. Although the exact reason is unclear, it is presumed that the coexistence of a specific pyrrolidone compound and the compound represented by formula (1) above allows the specific pyrrolidone compound to exert its ability to solubilize dyes well with a reduced amount of it. As a result of this, presumably, the viscosity of the ink jet ink composition is a value appropriate for ejection from an ink jet head. At the same time, the solubility of dyes in the ink jet composition is maintained, helping make recovery from clogging better and, moreover, make ejection stability excellent as well. As stated later herein, furthermore, such advantages are obtained even when the amount of the compound represented by formula (1) above is relatively small.

Incidentally, when relatively large amounts of surfactant and additives are used in an ink jet ink composition in which the dye is a disperse dye, increased hydrophilicity of the system can cause so-called oil-like separation because of an increased likelihood of the separation of the surfactant and additives. As stated above, the specific pyrrolidone compounds exhibit high hydrophilicity. With a certain amount of specific pyrrolidone compound, therefore, there is concern that oil-like separation will occur. In this aspect of the present disclosure, however, the inclusion of the compound represented by formula (1) above together with a specific pyrrolidone compound produces the effect of lessening the hydrophilicity of the specific pyrrolidone compound, helping control oil-like separation well. Such an advantage is obtained even when the amount of the compound represented by formula (1) above is relatively small as described below.

The amount of the compound represented by formula (1) above in the ink jet ink composition is preferably 0.01% by mass or more and 3.0% by mass or less, more preferably 0.03% by mass or more and 1.5% by mass or less, even more preferably 0.05% by mass or more and 0.8% by mass or less.

This allows the occurrence of issues such as oil-like separation to be reduced more effectively. At the same time, the solubility of the dye in the ink jet ink composition becomes better, making it less likely that the separation and solidification of the dye will occur. The ejection stability and recovery from clogging of the ink jet ink composition, therefore, become better.

It is preferred that 0.001≤X2/X1≤0.80, where X1 is the amount of the specific pyrrolidone compounds, i.e., the sum of the amounts of 1-(2-hydroxyethyl)-2-pyrrolidone and 2-pyrrolidone, in the ink jet ink composition [% by mass], and X2 is the amount of the compound represented by formula (1) above in the ink jet ink composition [% by mass]. More preferably, 0.005≤X2/X1≤0.75. Even more preferably, 0.010≤X2/X1≤0.67.

This allows the occurrence of issues such as oil-like separation to be reduced more effectively. At the same time, the solubility of the dye in the ink jet ink composition becomes better, making it less likely that the separation and solidification of the dye will occur. The ejection stability and recovery from clogging of the ink jet ink composition, therefore, become better.

### 1-3-3 Extra Organic Solvent Components

The ink jet ink composition according to this aspect of the present disclosure may contain organic solvent components other than the above-described specific pyrrolidone compounds and compound represented by formula (1) above. Such organic solvent components are hereinafter referred to as “extra organic solvent components.”

Examples of extra organic solvent components include alkyl polyols, glycol ethers, cyclic amides other than the specific pyrrolidone compounds and the compound represented by formula (1) above, γ-butyrolactone and other lactones, and betaine compounds. One or a combination of two or more selected from these can be used.

In particular, the inclusion of an alkyl polyol further increases the moisture retention of the ink jet ink composition, helping make stability in ejection by ink jet technology better. At the same time, the inclusion of an alkyl polyol allows water evaporation from the recording head during a long period of leave to be reduced more effectively. This also allows recovery after leave and stability in continuous ejection to be maintained better, even when a type of dye likely to cause the clogging of nozzles is used.

Examples of alkyl polyols include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, diethylene glycol, propylene glycol, dipropylene glycol, triethylene glycol, and glycerol. One or a combination of two or more selected from these can be used.

When the ink jet ink composition is one that contains at least one alkyl polyol, the amount of the alkyl polyol in the ink jet ink composition is preferably 3.0% by mass or more and 40.0% by mass or less, more preferably 4.0% by mass or more and 25.0% by mass or less, even more preferably 5.0% by mass or more and 20.0% by mass or less.

This ensures that the advantages resulting from the inclusion of a specific pyrrolidone compound and the compound represented by formula (1) above will be produced sufficiently. At the same time, the advantages resulting from the inclusion of an alkyl polyol become more significant.

When the ink jet ink composition is one that contains at least one alkyl polyol, it is more preferred that the alkyl polyol include an alkanediol with three or more and six or fewer carbons.

Examples of alkanediols with three or more and six or fewer carbons include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-1,3-propanediol, 2,2-dimethyl-1,3-propanediol, 3-methyl-1,3-butanediol, 3-methyl-1,5-pentanediol, and 2-methylpentane-2,4-diol.

When the ink jet ink composition contains an alkanediol with three or more and six or fewer carbons, the balance of hydrophilicity in the ink jet ink composition as a whole is better, helping achieve better ejection stability, better reliability in continuous ejection in particular. The solubility or dispersibility of the dye, furthermore, is better, helping make recovery from clogging better.

Examples of glycol ethers include monoalkyl ethers and dialkyl ethers of glycols selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. More specific examples include triethylene glycol monomethyl ether, triethylene glycol monobutyl ether, diethylene glycol monobutyl ether, and dipropylene glycol monopropyl ether. One or a combination of two or more selected from these can be used.

Of these glycol ethers, it is particularly preferred that the ink jet ink composition contain a glycol ether represented by formula (2) below.

R¹—O—(CH₂—CH₂—O)ₙ—R² (2)

(In formula (2), R¹ is H or an alkyl group with one or more and four or fewer carbons, R² is an alkyl group with one or more and four or fewer carbons, and n is 2 or 3.)

Examples of glycol ethers represented by formula (2) above include triethylene glycol monomethyl ether, triethylene glycol monobutyl ether, diethylene glycol monobutyl ether, triethylene glycol dimethyl ether, triethylene glycol dibutyl ether, and diethylene glycol dibutyl ether.

When the ink jet ink composition contains a glycol ether represented by formula (2) above, the balance of hydrophilicity in the ink jet ink composition as a whole is better, helping achieve better ejection stability, better reliability in continuous ejection in particular. The solubility or dispersibility of the dye, furthermore, is better, helping make recovery from clogging better.

When the ink jet ink composition is one that contains a glycol ether, the amount of the glycol ether in the ink jet ink composition is preferably 0.5% by mass or more and 15.0% by mass or less, more preferably 1.0% by mass or more and 12.0% by mass or less, even more preferably 3.0% by mass or more and 10.0% by mass or less.

This allows the viscosity of the ink jet ink composition to be adjusted better, thereby allowing the clogging of the ink jet head caused by the moisture-retaining effect of the ink jet ink composition to be reduced more effectively.

Examples of cyclic amides other than the specific pyrrolidone compounds and the compound represented by formula (1) above include γ-lactams, such as 1-methyl-2-pyrrolidone, 1-ethyl-2-pyrrolidone, 1-propyl-2-pyrrolidone, and 1-butyl-2-pyrrolidone, ε-lactams, δ-lactams, and ε-lactams, such as ε-caprolactam. One or a combination of two or more selected from these can be used.

### 1-4 Surfactant

The ink jet ink composition according to this aspect of the present disclosure may contain a surfactant.

Surfactants reduce the surface tension of the ink jet ink composition and can be used to adjust or improve the wettability of the composition on the recording medium, such as penetrability into, for example, fabric. When the ink jet ink composition contains a surfactant, furthermore, stability in the ejection of the ink from a head tends to increase.

Surfactants that can be used include different types of surfactants, such as anionic surfactants, cationic surfactants, and nonionic surfactants.

Among different types of surfactants, acetylene glycol surfactants, silicone surfactants, and fluorosurfactants are particularly preferred for use.

Examples of acetylene glycol surfactants include Surfynol 104, 104E, 104H, 104A, 104BC, 104DPM, 104PA, 104PG-50, 104S, 420, 440, 465, 485, 504, 61, AD01, CT111, CT121, CT131, CT136, DF110D, DF37, GA, MD-20, PSA-336, SE, SE-F, and TG (trade names, manufactured by Air Products and Chemicals Inc.), OLFINE B, Y, P, A, STG, SPC, E1004, E1010, PD-001, PD-002W, PD-003, PD-004, PD-005, EXP.4001, EXP. 4036, EXP.4051, EXP.4123, EXP.4200, EXP.4300, AF-103, AF-104, AK-02, SK-14, and AE-3 (trade names, manufactured by Nissin Chemical Industry Co., Ltd.), and ACETYLENOL E00, EOOP, E40, and E100 (manufactured by Kawaken Fine Chemicals Co., Ltd.).

Examples of preferred silicone surfactants include polysiloxane compounds, although silicone surfactants that can be used are not particularly limited. Examples of the polysiloxane compounds include polyether-modified organosiloxanes. Examples of the polyether-modified organosiloxanes include BYK-306, BYK-307, BYK-333, BYK-341, BYK-345, BYK-346, and BYK-348 (trade names, manufactured by BYK-Chemie GmbH) and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemical Co., Ltd.).

A fluorosurfactant can be a fluorine-modified polymer. An example of a fluorosurfactant is BYK-340 (trade name, manufactured by BYK Japan KK).

The percentage of the surfactant in the ink jet ink composition is preferably 0.05% by mass or more and 1.0% by mass or less, more preferably 0.10% by mass or more and 0.90% by mass or less, even more preferably 0.15% by mass or more and 0.80% by mass or less.

### 1-5 Chelating Agent

The ink jet ink composition according to this aspect of the present disclosure may contain a chelating agent.

This allows predetermined ions in the ink jet ink composition to be removed well.

Examples of chelating agents include ethylenediaminetetraacetic acid and its salts, such as EDTA, EDTA-2Na, EDTA-3Na, EDTA-4Na, and EDTA-3K, diethylenetriaminepentaacetic acid and its salts, such as DTPA, DTPA-2Na, and DTPA-5Na, nitrilotriacetic acid and its salts, such as NTA, NTA-2Na, and NTA-3Na, ethylenediamine-N, N′-disuccinic acid and its salts, 3-hydroxy-2,2′-iminodisuccinic acid and its salts, L-aspartic acid-N, N′-diacetic acid and its salts, L-glutamic acid diacetic acid and its salts, N-(1-carboxylatomethyl)iminodiacetic acid and its salts, and N-(2-hydroxyethyl)iminodiacetic acid and its salts.

Examples of chelating agents other than acetic acid analogues, furthermore, include ethylenediamine tetramethylene phosphonic acid and its salts, ethylenediamine tetrametaphosphoric acid and its salts, ethylenediamine pyrophosphoric acid and its salts, and ethylenediamine metaphosphoric acid and its salts.

1-6 pH-Adjusting Agent

The ink jet ink composition according to this aspect of the present disclosure may contain a pH-adjusting agent.

An example of a pH-adjusting agent is an appropriate combination of an acid, a base, a weak acid, and a weak base. Examples of acids and bases used in such a combination include sulfuric acid, hydrochloric acid, nitric acid, etc., for inorganic acids, lithium hydroxide, sodium hydroxide, potassium hydroxide, potassium dihydrogenphosphate, disodium hydrogenphosphate, potassium carbonate, sodium carbonate, sodium hydrogencarbonate, ammonia, etc., for inorganic bases, triethanolamine, diethanolamine, monoethanolamine, tripropanolamine, triisopropanolamine, diisopropanolamine, trishydroxymethylaminomethane, etc., for organic bases, and adipic acid, citric acid, succinic acid, lactic acid, N, N-bis (2-hydroxyethyl)-2-aminoethanesulfonic acid, 4-(2-hydroxyethyl)-1-piperazineethanesulfonic acid, morpholinoethanesulfonic acid, morpholinopropanesulfonic acid, carbamoylmethyliminobisacetic acid, piperazine-1,4-bis(2-ethanesulfonic acid), N-(2-acetamido)-2-aminoethanesulfonic acid, colamine hydrochloride, N-tris (hydroxymethyl)methyl-2-aminoethanesulfonic acid, etc., for organic acids. Compounds such as Good's buffers, including acetamidoglycine, tricine, glycinamide, and bicine, phosphate buffers, citrate buffers, and tris buffers may also be used.

### 1-7 Binder Resin

The ink jet ink composition according to this aspect of the present disclosure may contain a binder resin.

This helps further improve the adhesion, for example, of images formed by the ink jet ink composition attached to a recording medium.

The binder resin may be contained in the ink jet ink composition in any form, but preferably, it is contained as particles.

Examples of binder resins include urethane resins, acrylic resins (including styrene-acrylic resins), fluorene resins, polyolefin resins, rosin-modified resins, terpene resins, polyester resins, polyamide resins, epoxy resins, vinyl chloride resins, vinyl chloride-vinyl acetate copolymers, and ethylene vinyl acetate resins. Of these, urethane resins, acrylic resins, polyolefin resins, and polyester resins are particularly preferred.

Urethane resin is a generic term for resins having a urethane linkage. A urethane resin may be a polyether urethane resin, which contains, besides the urethane linkage, an ether linkage in its backbone, a polyester urethane resin, which contains an ester linkage in its backbone, or a polycarbonate urethane resin, which contains a carbonate linkage in its backbone.

Commercially available urethane resins may also be used. Examples of commercially available urethane resins include SUPERFLEX 460, 460s, 840, and E-4000 (trade names, manufactured by DKS Co., Ltd.), RESAMINE D-1060, D-2020, D-4080, D-4200, D-6300, and D-6455 (trade names, manufactured by Dainichiseika Color & Chemicals Mfg. Co., Ltd.), Takelac WS-5100, WS-6021, W-6020, and W-512-A-6 (trade names, manufactured by Mitsui Chemicals Polyurethanes, Inc.), Sancure 2710 (trade name, manufactured by The Lubrizol Corporation), and PERMARIN UA-150 (trade name, manufactured by Sanyo Chemical Industries, Ltd.).

Acrylic resin is a generic term for polymers containing at least an acrylic monomer, such as (meth)acrylic acid or a (meth)acrylate, as their constituent monomer. Examples include resins made from acrylic monomers and copolymers of acrylic and other monomers. Examples of the copolymers include acryl-vinyl resins, which are copolymers of acrylic and vinyl monomers. An example of a vinyl monomer is styrene.

Acrylic monomers that can be used also include monomers such as acrylamide and acrylonitrile. Commercially available resin emulsions made with an acrylic resin may also be used. For example, one or more selected from products such as FK-854 (trade name, manufactured by Japan Coating Resin Co., Ltd.), Mowinyl 952B and 718A (trade names, manufactured by The Nippon Synthetic Chemical Industry Co., Ltd.), and Nipol LX852 and LX874 (trade names, manufactured by Zeon Corporation) may be used.

It should be noted that an acrylic resin herein may be a styrene-acrylic resin, which will be described later.

Styrene-acrylic resins are copolymers made from the styrene monomer and an acrylic monomer. Examples include styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers. Commercially available styrene-acrylic resins may also be used. Examples of commercially available styrene-acrylic resins include Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, manufactured by BASF SE), Mowinyl 966A and 975N (trade names, manufactured by The Nippon Synthetic Chemical Industry Co., Ltd.), and VINYBLAN 2586 (manufactured by Nissin Chemical Industry Co., Ltd.).

Polyolefin resins are resins having an olefin, such as ethylene, propylene, or butylene, in their structural backbone, and one or more of them can be selected from known ones and used as needed. Commercially available olefin resins may also be used. Examples of commercially available polyolefin resins include ARROWBASE CB-1200 and CD-1200 (trade names, manufactured by UNITIKA Ltd.).

### 1-8 Extra Ingredients

The ink jet ink composition according to this aspect of the present disclosure may contain ingredients other than the ingredients described above. Such ingredients are hereafter referred to as “extra ingredients” in this section.

Examples of extra ingredients include preservatives; antimolds; ureas; saccharides; antirusts; flame retardants; types of dispersants; pigments; antioxidants; ultraviolet absorbers; oxygen absorbers; dissolution aids; and penetrants.

Examples of preservatives/antimolds include sodium benzoate, sodium pentachlorophenate, sodium 2-pyridinethiol-1-oxide, sodium sorbate, sodium dehydroacetate, 1,2-dibenzisothiazolin-3-one, and 4-chloro-3-methylphenol. An example of an antirust is benzotriazole.

For use as preservatives/antimolds, compounds having an isothiazolinone ring structure in their molecule, for example, are suitable.

Examples of ureas include urea, ethylene urea, tetramethylurea, thiourea, and 1,3-dimethyl-2-imidazolidinone.

Examples of saccharides include glucose, mannose, fructose, ribose, xylose, arabinose, galactose, aldonic acid, glucitol (sorbitol), maltose, cellobiose, lactose, sucrose, trehalose, and maltotriose.

The percentage of extra ingredients in the ink jet ink composition according to this aspect of the present disclosure is preferably 6.0% by mass or less, more preferably 5.0% by mass or less.

The lower limit to the percentage of extra ingredients is 0% by mass.

### 1-9 Others

The surface tension at 25° C. of the ink jet ink composition according to this aspect of the present disclosure is not particularly limited, but preferably is 20 mN/m or more and 60 mN/m or less, more preferably 25 mN/m or more and 50 mN/m or less, even more preferably 27 mN/m or more and 40 mN/m or less.

This further reduces the likelihood of, for example, the clogging of nozzles of the ink jet head, thereby further improving ejection stability of the ink jet ink composition. Even when the clogging of nozzles occurs, furthermore, recovery after the capping of the nozzles is better.

The surface tension can be a value measured by the Wilhelmy method or the ring method. In the measurement of the surface tension, a surface tensiometer (e.g., DY-300, DY-500, or DY-700, manufactured by Kyowa Interface Science Co., Ltd.) can be used.

The viscosity at 25° C. of the ink jet ink composition according to this aspect of the present disclosure is preferably 2 mPa·s or more and 10 mPa·s or less, more preferably 3 mPa·s or more and 8 mPa·s or less.

This makes the stability of the ink jet ink composition in ejection by ink jet technology better.

The viscosity can be determined by measuring it with a vibrational viscometer, rotational viscometer, capillary viscometer, or falling-ball viscometer. With a vibrational viscometer, for example, the viscosity can be determined through a measurement according to JIS Z8809.

The ink jet ink composition according to this aspect of the present disclosure only needs to be one that is subjected to ejection by ink jet technology. Examples of ink jet methods include the charging and deflection method, the continuous method, and the piezoelectric, Bubble-Jet®, and other drop-on-demand methods. The ink jet ink composition according to this aspect of the present disclosure, however, is particularly preferably one that is ejected from an ink jet head including piezoelectric actuators.

This results in more effective prevention of unwanted denaturation, for example, of the constituents of the ink jet ink composition in the ink jet head, helping make stability in ejection by ink jet technology better.

As described above, an ink jet ink composition according to this aspect of the present disclosure only needs to be one that contains at least one dye, an organic solvent, and water and that contains, as the organic solvent, at least one selected from the group consisting of 1-(2-hydroxyethyl)-2-pyrrolidone and 2-pyrrolidone and the compound represented by formula (1) above. Preferably, however, the ink jet ink composition contains, as the organic solvent, at least one selected from the group consisting of alkanediols with three or more and six or fewer carbons and glycol ethers represented by formula (2) above besides the at least one selected from the group consisting of 1-(2-hydroxyethyl)-2-pyrrolidone and 2-pyrrolidone and compound represented by formula (1) below, the sum of the amounts of 1-(2-hydroxyethyl)-2-pyrrolidone and 2-pyrrolidone in the ink jet ink composition is 0.5% by mass or more and 15.0% by mass or less, the amount of the compound represented by formula (1) above in the ink jet ink composition is 0.01% by mass or more and 3.0% by mass or less, 0.001≤X2/X1≤0.80, where X1 is the sum of the amounts of 1-(2-hydroxyethyl)-2-pyrrolidone and 2-pyrrolidone in the ink jet ink composition [% by mass], and X2 is the amount of the compound represented by formula (1) above in the ink jet ink composition [% by mass], the dye is at least one water-soluble dye selected from the group consisting of acid dyes, direct dyes, and reactive dyes, and the amount of the water-soluble dye in the ink jet ink composition is 5.0% by mass or more and 20.0% by mass or less.

This results in synergistic effects of the individual advantages described above, leading to a particularly excellent benefit.

### 3 Recording Method

A recording method according to an aspect of the present disclosure will now be described.

A recording method according to an aspect of the present disclosure includes attaching an ink jet ink composition according to an aspect of the present disclosure to a recording medium by ejecting the ink jet ink composition by ink jet technology.

This allows a recording method to be provided with which the ink jet composition can be ejected with excellent stability, the ink jet head recovers well from any clogging, and recorded articles with a recorded area formed thereon in the desired pattern can be produced in a stable manner.

Notably, the recording method according to this embodiment includes an ejection step in which an ink jet ink composition according to an aspect of the present disclosure is applied to a recording medium by the ink jet technique.

### 3-1 Ejection Step

In the ejection step, an ink jet ink composition according to an aspect of the present disclosure is ejected as droplets by ink jet technology, and the droplets are attached to a recording medium. Through this, the desired image is formed. The formation of the image may be performed using multiple types of ink jet ink compositions, such as multiple types of ink jet ink compositions according to an aspect of the present disclosure.

The ink jet technology with which the ink jet ink composition is ejected may be of any method. Examples include the charging and deflection method, the continuous method, and the piezoelectric, Bubble-Jet®, and other drop-on-demand methods.

The recording medium is not particularly limited, but examples include types of fabric, ordinary printing paper and other types of paper, recording media having an ink-receiving layer, called dedicated paper for ink jet recording or coated paper, plastic films, made from polyethylene terephthalate, polypropylene, or other types of plastics, metals, and glass.

Transfer paper for performing sublimation transfer to recording media, furthermore, can also be a recording medium in an ink jet textile-printing recording method.

Fabric is not particularly limited, and examples of materials that form the fabric include natural fibers, such as cotton, hemp, wool, and silk, synthetic fibers, such as polypropylene, polyester, acetate, triacetate, polyamide, and polyurethane, and biodegradable fibers, such as polylactic acid. A blend of these fibers may also be used. The fabric may be any form of the fibers listed above, such as woven, knitted, or nonwoven fabric. The fabric may be one that is, for example, woven from multiple materials.

In the recording method according to this aspect of the present disclosure, not only ink jet ink compositions according to an aspect of the present disclosure but also other ink compositions may be used in combination with them. For example, in the recording method according to this aspect of the present disclosure, inks containing a pigment may be used together with ink jet ink compositions according to an aspect of the present disclosure.

### 4 Recorded Article

A recorded article according to an aspect of the present disclosure is one produced using an ink jet ink composition according to an aspect of the present disclosure as described above and can be produced using the recording method described above.

Preferred embodiments of aspects of the present disclosure have been described hereinabove. No aspect of the present disclosure, however, is limited to these.

### EXAMPLES

Specific examples of the present disclosure will now be described.

### 5 Preparation of Ink Jet Ink Compositions

### Example 1

Ingredients were put into a container to the formulation presented in the FIGURE and mixed and stirred with a magnetic stirrer for 2 hours. Then the resulting mixture was filtered through a membrane filter with a pore size of 5 μm to give an ink jet ink composition.

### Examples 2 to 11

Ink jet ink compositions were prepared in the same manner as in Example 1 above, except that the types of ingredients used to prepare the ink jet ink composition and the proportions of the ingredients were changed to the formulation presented in the FIGURE.

### Comparative Example 1

An ink jet ink composition was prepared in the same manner as in Example 1 above, except that the types of ingredients used to prepare the ink jet ink composition and the proportions of the ingredients were changed to the formulation presented in the FIGURE.

### Comparative Example 2

Pigment Red 122, Takelac W-6020 (trade name, manufactured by Mitsui Chemicals Polyurethanes, Inc.), triisopropanolamine, and purified water were mixed together in a predetermined ratio, and dispersion treatment was performed for 10 hours in a ball mill with zirconia beads to give a stock dispersion. Then the resulting stock dispersion was filtered through a membrane filter with a pore size of approximately 8 μm so that coarse particles would be removed, and the filtrate was diluted with purified water to a pigment concentration of 10% by mass. In this manner, a pigment dispersion was prepared. Then, of the materials listed in the FIGURE, the ingredients excluding Pigment Red 122, Takelac W-6020, and triisopropanolamine were put into a container and stirred and mixed together. The pigment dispersion was added to this in a predetermined ratio. Purified water for concentration adjustment was also added, and the resulting mixture was stirred for 2 hours and filtered through a membrane filter with a pore size of approximately 5 μm to give an ink jet ink composition.

### Comparative Example 3

An ink jet ink composition was prepared in the same manner as in Example 1 above, except that the types of ingredients used to prepare the ink jet ink composition and the proportions of the ingredients were changed to the formulation presented in the FIGURE.

A summary of the formulations of the ink jet ink compositions of the Examples and Comparative Examples above is presented in the FIGURE. It should be noted that in the FIGURE, the unit for the amounts of ingredients is % by mass, and C.I. Reactive Yellow 95 is expressed as “RY95,” C.I. Reactive Red 254 as “RR254,” C. I. Acid Yellow 79 as “AY79,” C. I. Direct Blue 87 as “DB87,” C. I. Pigment Red 122 as “PR122,” 2-pyrrolidone as “2-PY,” 1-(2-hydroxyethyl)-2-pyrrolidone as “HEP,” the compound represented by formula (1) above as “COMPOUND (1),” glycerol as “GLY,” diethylene glycol as “DEG,” propylene as “PG,” triethylene glycol as “TEG,” triethylene glycol monobutyl ether as “TEGMBE,” Takelac W-6020 (trade name, manufactured by Mitsui Chemicals Polyurethanes, Inc.) as “W6020,” triisopropanolamine as “TIPA,” triethanolamine as “TEA,” adipic acid as “AA,” OLFINE PD-002W (trade name, manufactured by Nissin Chemical Industry Co., Ltd.) as “PD002W,” OLFINE E1010 (trade name, manufactured by Nissin Chemical Industry Co., Ltd.) as “E1010,” ethylenediaminetetraacetic acid as “EDTA,” and Proxel XL2 (trade name, manufactured by Arxada AG) as “XL2.” For the ink jet ink compositions of the Examples above, furthermore, the surface tension at 25° C. was a value in the range of 30 mN/m to 40 mN/m, and the viscosity at 25° C. was a value in the range of 3 mPa's to 8 mPas, for all of them. The surface tension was measured by the Wilhelmy method using a surface tensiometer (DY-300, manufactured by Kyowa Interface Science Co., Ltd.), and the viscosity was determined through a measurement according to JIS Z8809 using a vibrational viscometer (VM-100, manufactured by Sekonic Corporation).

### 6 Evaluations

### 6-1 Clogging Evaluation

The ink jet ink compositions of the Examples and Comparative Examples above were each loaded into an EW-M770T ink jet printer (trade name, Seiko Epson Corporation), and a nozzle check pattern was printed and checked to ensure that there was no incomplete loading/nozzle clogging. Then the printer was brought into a state in which its head had returned to its home position. In this state, the printer was left in a 40° C./20% RH environment for 2 weeks. After that, a nozzle check pattern was printed, and the status of ejection of nozzles was observed and evaluated according to the following criteria.

A: The ink normally came out from all nozzles with one cycle of cleaning.

B: The ink normally came out from all nozzles with the number of cycles of cleaning being in the range of two to five.

C: The ink normally came out from all nozzles with the number of cycles of cleaning being in the range of six to ten.

D: The ink did not normally come out from all nozzles even after cleaning was performed eleven cycles or more.

### 6-2 Continuous Ejection Evaluation

The ink jet ink compositions of the Examples and Comparative Examples above were each loaded into an EW-M770T ink jet printer (trade name, Seiko Epson Corporation), and a nozzle check pattern was printed and checked to ensure that there was no incomplete loading/nozzle clogging. Then, immediately, 10 hours of continuous ejection was performed in a 25° C./50% RH environment, and an evaluation was made according to the following criteria. The cleaning was performed every 2 hours.

A: No misfiring or disturbed ejection occurred during the ejection.

B: Defects such as misfiring and disturbed ejection occurred to some degree during the ejection, but the printer recovered during the ejection.

C: Defects such as misfiring and disturbed ejection occurred to some degree during the ejection. The printer did not recover during the ejection but recovered with cleaning.

D: Misfiring and disturbed ejection occurred during the ejection. The printer did not recover during the ejection and failed to recover even with cleaning.

### 6-3 Low-Temperature Leave Evaluation

The ink jet ink compositions of the Examples and Comparative Examples above were each sealed in a pack and left in a −20° C. environment for 4 days. Then the ink compositions were acclimatized to room temperature, and 10 mL of each was passed through a membrane filter with a pore size of 10 μm. The membrane filter after the passage of the ink composition was observed, and an evaluation was made according to the following criteria.

A: No aggregate was observed.

B: The ink composition passed, but aggregates were observed.

C: The ink composition failed to pass, and numerous aggregates were observed.

A summary of the results of these evaluations is presented in the FIGURE.

As is clear from the FIGURE, excellent results were obtained with aspects of the present disclosure. In contrast, in the Comparative Examples, no satisfactory results were obtained.

What is claimed is:

1. An ink jet ink composition comprising at least one dye, an organic solvent, and water, wherein:
the ink jet ink composition contains, as the organic solvent, at least one selected from the group consisting of 1-(2-hydroxyethyl)-2-pyrrolidone and 2-pyrrolidone and a compound represented by formula (1) below.

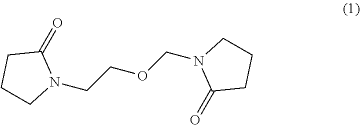 [SMILES: O=C1CCCN1CCOCN1CCCC1=O]

2. The ink jet ink composition to claim 1, wherein:
a sum of amounts of the 1-(2-hydroxyethyl)-2-pyrrolidone and the 2-pyrrolidone in the ink jet ink composition is 0.5% by mass or more and 15.0% by mass or less.

3. The ink jet ink composition according to claim 1, wherein:
an amount of the compound represented by formula (1) above in the ink jet ink composition is 0.01% by mass or more and 3.0% by mass or less.

4. The ink jet ink composition according to claim 1, wherein:
0.001≤X2/X1≤0.80, where X1 is a sum of amounts of the 1-(2-hydroxyethyl)-2-pyrrolidone and the 2-pyrrolidone in the ink jet ink composition in % by mass, and X2 is an amount of the compound represented by formula (1) above in the ink jet ink composition in % by mass.

5. The ink jet ink composition according to claim 1, further comprising:
as the organic solvent, at least one selected from the group consisting of alkanediols with three or more and six or fewer carbons and glycol ethers represented by formula (2) below:
R¹—O—(CH₂—CH₂—O)ₙ—R² (2)
where R¹ is H or an alkyl group with one or more and four or fewer carbons, R² is an alkyl group with one or more and four or fewer carbons, and n is 2 or 3.

6. The ink jet ink composition according to claim 1, wherein:
the dye is at least one water-soluble dye.

7. The ink jet ink composition according to claim 6, wherein:
the water-soluble dye is at least one selected from the group consisting of acid dyes, direct dyes, and reactive dyes.

8. The ink jet ink composition according to claim 6, wherein:
an amount of the water-soluble dye in the ink jet ink composition is 5.0% by mass or more and 20.0% by mass or less.

9. An ink jet ink composition comprising at least one dye, an organic solvent, and water, wherein:
the ink jet ink composition contains, as the organic solvent, at least one selected from the group consisting of 1-(2-hydroxyethyl)-2-pyrrolidone and 2-pyrrolidone, a compound represented by formula (1) below, and at least one selected from the group consisting of alkanediols with three or more and six or fewer carbons and glycol ethers represented by formula (2) below;
a sum of amounts of the 1-(2-hydroxyethyl)-2-pyrrolidone and the 2-pyrrolidone in the ink jet ink composition is 0.5% by mass or more and 15.0% by mass or less;
an amount of the compound represented by formula (1) below in the ink jet ink composition is 0.01% by mass or more and 3.0% by mass or less;
0.001≤X2/X1≤0.80, where X1 is the sum of amounts of the 1-(2-hydroxyethyl)-2-pyrrolidone and the 2-pyrrolidone in the ink jet ink composition in % by mass, and X2 is the amount of the compound represented by formula (1) below in the ink jet ink composition in % by mass;
the dye is at least one water-soluble dye selected from the group consisting of acid dyes, direct dyes, and reactive dyes; and
an amount of the water-soluble dye in the ink jet ink composition is 5.0% by mass or more and 20.0% by mass or less: 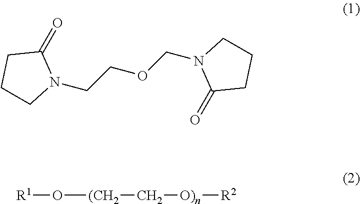
where R is H or an alkyl group with one or more and four or fewer carbons, R is an alkyl group with one or more and four or fewer carbons, and n is 2 or 3.

10. A recording method comprising:
attaching the ink jet ink composition according to claim 1 to a recording medium by ejecting the ink jet ink composition by ink jet technology.
